(19) United States
(12) Patent Application Publication
(10) Pub. No.: US 2015/0093657 A1
(43) Pub. Date: Apr. 2, 2015

(54) DIRECT ALUMINUM FUEL CELL AND ELECTRONIC DEVICE

(71) Applicant: SONY CORPORATION, Tokyo (JP)

(72) Inventors: Takaaki Nakagawa, KanagawaP (JP); Kenichi Murata, KanagawaP (JP); Tsunetoshi Samukawa, KanagawaP (JP)

(21) Appl. No.: 14/397,904

(22) PCT Filed: Apr. 19, 2013
(86) PCT No.: PCT/JP2013/061586

§ 371 Date: Oct. 30, 2014

(30) Foreign Application Priority Data
May 9, 2012 (JP) 2012-107338

(51) Int. Cl. H01M 12/06

(52) U.S. Cl. CPC H01M 12/06; H01M 12/065; H01M 2300/00
USPC 429/404; 429/405

(57) ABSTRACT

The present disclosure relates to a direct aluminum fuel cell including: an anode 11 including an aluminum-containing material; a cathode 12 capable of reducing oxygen under neutral or near-neutral conditions; a separator 13 provided between the anode 11 and the cathode 12; and an electrolytic solution with a pH of 3 to 10, wherein the electrolytic solution contains a buffer substance.

### TECHNICAL FIELD

The present disclosure relates to a direct aluminum fuel cell and an electronic device. More specifically, the present disclosure relates to a direct aluminum fuel cell that is designed to generate electricity by using an anode including an aluminum-containing material as a fuel and using oxygen in the air as a cathode active material, and also relates to various types of electronic devices including such a direct aluminum fuel cell.

### BACKGROUND ART

An air cell (also called metal-air cell), which uses a high-energy-density metal as an anode active material and uses oxygen in the air as a cathode active material, can operate with a half cell configuration, which makes it possible to reduce the amount of electrode active material to half. Theoretically, such an air cell can attain a high energy density. An aluminum-air cell using an aluminum anode is known as a type of such an air cell and expected to be a large-capacity cell (see, for example, Patent Documents 1 to 3).

To increase the power of conventional aluminum-air cells, investigations have been carried out in which alkaline solutions are used as electrolytes to improve cathode reaction.

### CITATION LIST

### Patent Documents

Patent Document 1: Japanese Patent Application Laid-Open No. 2002-184472

Patent Document 2: Japanese Patent Application Laid-Open No. 2006-147442

Patent Document 3: Japanese Patent Application Laid-Open No. 2012-15025

Patent Document 4: Japanese Patent Application Laid-Open No. 2008-273816

### SUMMARY OF THE INVENTION

### Problems to be Solved by the Invention

However, conventional aluminum-air cells using alkaline solutions as electrolytes have problems such as alkaline electrolyte-induced severe corrosion of aluminum and cathode degradation which occurs as the alkaline electrolyte is gradually neutralized by absorbing carbon dioxide in the air.

It is therefore an object of the present disclosure to provide a direct aluminum fuel cell in which aluminum as an anode component used as a fuel is prevented from being corroded and the cathode is also prevented from being degraded, and to provide an electronic device having such a direct aluminum fuel cell.

### Solutions to Problems

To achieve the object, a first mode of the present disclosure is directed to a direct aluminum fuel cell including: an anode including an aluminum-containing material; a cathode capable of reducing oxygen under neutral or near-neutral conditions; and an electrolytic solution with a pH of 3 to 10, wherein the electrolytic solution contains a buffer substance.

To achieve the object, a second mode of the present disclosure is directed to a direct aluminum fuel cell including: an anode including an aluminum-containing material; and a cathode capable of reducing oxygen under neutral or near-neutral conditions.

To achieve the object, the present disclosure is also directed to an electronic device including at least one piece of the direct aluminum fuel cell according to the first or second mode of the present disclosure.

In the direct aluminum fuel cell according to the first or second mode of the present disclosure or in the direct aluminum fuel cell, according to the first or second mode of the present disclosure, installed in the electronic device of the present disclosure (hereinafter, these direct aluminum fuel cells are also generically referred to as “the direct aluminum fuel cell of the present disclosure and the like”), the buffer substance preferably has a pKₐ of 4 to 10, which makes it possible to keep the electrolytic solution at a pH of 3 to 10.

Basically, the buffer substance may be of any type having a pKₐ of 4 to 10, which may be selected as needed. The content of the buffer substance in the electrolytic solution is preferably 0.2 mol or more per liter of the electrolytic solution. The upper limit to the content of the buffer substance in the electrolytic solution may be the maximum solubility of the buffer substance in the electrolytic solution. The content of the buffer substance in the electrolytic solution is more preferably close to the maximum solubility of the buffer substance in the electrolytic solution. In the direct aluminum fuel cell of the present disclosure and the like including those of such a preferred mode, the electrolytic solution may contain halide ions. In this case, the halide ions are preferably chloride ions. In the direct aluminum fuel cell of the present disclosure and the like including those of the preferred mode stated above, the cathode may be designed to be capable of reducing oxygen under conditions with a pH of 3 to 10.The cathode may be an immobilized enzyme electrode including an electrode and an enzyme immobilized thereon.

Alternatively, the cathode may be an electrode including a material capable of reducing oxygen, such as carbon (including charcoal), metal, carbon and metal, or a catalyst (specifically, an oxygen-reducing catalyst or a catalyst capable of reducing oxygen). Alternatively, the cathode may be an electrode containing a catalyst capable of allowing oxygen to undergo four-electron reduction under neutral or near-neutral conditions (for example, the catalyst may be an enzyme). Typically, the direct aluminum fuel cell has a separator between the anode and the cathode. The shape of the anode may be selected as needed. For example, the anode may have a foil shape, a sheet shape, or a plate shape. To increase the contact area between the anode and oxygen, if necessary, at least part of the anode, preferably almost the whole or the whole of the anode may be mesh-shaped or made of a porous material. In a typical example, the anode is made of an aluminum foil. If necessary, the anode may be exchangeably provided. Preferably, the direct aluminum fuel cell is so configured that an insoluble material as a by-product can be removed simultaneously with the exchange of the anode.

Basically, the electronic device may be of any type. The electronic device may be any of portable and stationary devices, examples of which include cellular phones, mobile devices, robots, personal computers, game machines, camera-integrated VTRs (video tape recorders), on-vehicle devices, a variety of home electric appliances, industrial products, and other products.

### Effects of the Invention

According to the present disclosure, oxygen is reduced at the cathode under neutral or near-neutral conditions, which makes it possible to prevent self-corrosion of aluminum and to prevent the problem of the degradation of the cathode in contrast to cases where alkaline solutions are used as electrolytes. Therefore, the present disclosure makes it possible to prevent the corrosion of aluminum as an anode component used as a fuel and also to provide a novel direct aluminum fuel cell in which the degradation of the cathode is prevented. The use of this advantageous direct aluminum fuel cell makes it possible to provide high-performance electronic devices and other products.

### BRIEF DESCRIPTION OF DRAWINGS

FIGS. 1A and 1B are schematic cross-sectional views showing a direct aluminum fuel cell of Example 1 and a modification thereof, respectively.

FIG. 2 is a graph showing the relationship between pH and the amount of corrosion of aluminum.

FIG. 3 is a graph showing the output characteristics of the direct aluminum fuel cell of Example 1.

FIG. 4 is a graph showing the amount of electric charges output from the direct aluminum fuel cell of Example 1.

FIG. 5 is a graph showing the results of an experiment that is performed to investigate the effect of chloride ions on the oxidation reaction of an aluminum foil with an area of 1 cm².

FIG. 6 is a schematic cross-sectional view showing a direct aluminum fuel cell of Example 3.

FIG. 7 is a graph showing the output characteristics of the direct aluminum fuel cell of Example 3.

FIGS. 8A, 8B, 8C, and 8D are schematic cross-sectional views showing a direct aluminum fuel cell of Example 4, the state of the fuel cartridge of the direct aluminum fuel cell of Example 4 before use, the state of the fuel cartridge of the direct aluminum fuel cell of Example 4 after use, and the state of the direct aluminum fuel cell of Example 4 after use, respectively.

FIG. 9 is a schematic cross-sectional view for illustrating a method for replacing the fuel cartridge with a new one in the direct aluminum fuel cell of Example 4.

### MODE FOR CARRYING OUT THE INVENTION

Hereinafter, the present disclosure will be described based on examples, which however are not intended to limit the present disclosure and in which different values and materials are by way of example only. Examples will be described in the following order.
1. Example 1 (a direct aluminum fuel cell, a method for manufacture thereof, and operation thereof)
2. Example 2 (a modification of Example 1)
3. Example 3 (another modification of Example 1)
4. Example 4 (a modification of Examples 1 to 3) and others

### Example 1

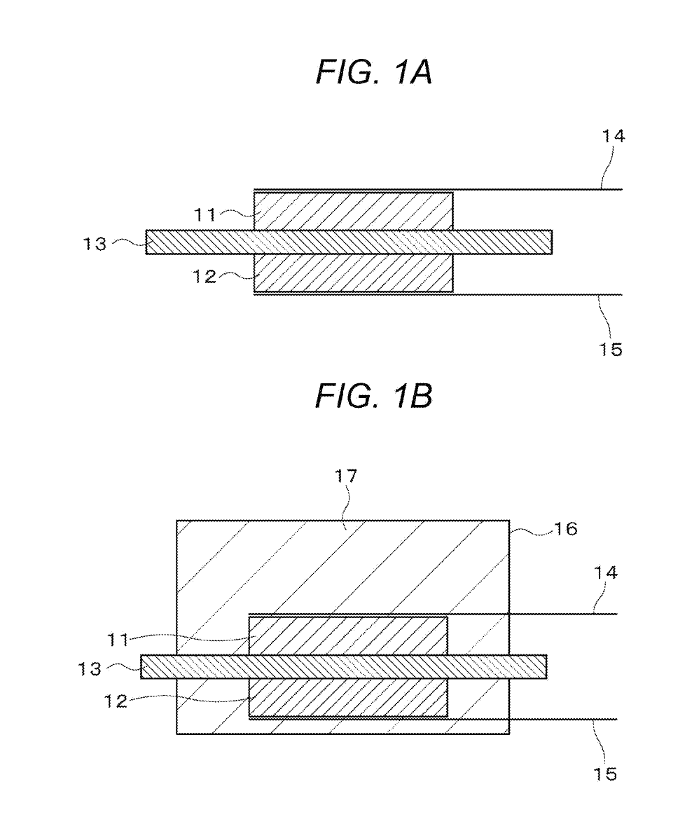

FIG. 1A is a schematic cross-sectional view showing a direct aluminum fuel cell of Example 1. The direct aluminum fuel cell of Example 1 includes an anode 11 including an aluminum-containing material, a cathode 12 capable of reducing oxygen under neutral or near-neutral conditions, and a separator 13 arranged between the anode 11 and the cathode 12. A collector 14 is electrically connected to the upper surface of the anode 11, and another collector 15 is electrically connected to the lower surface of the cathode 12. Typically, the anode 11, the cathode 12, and at least part of the separator 13 between the anode 11 and the cathode 12 are immersed in an electrolytic solution. The separator 13 is filled with the electrolytic solution and forms an electrolyte layer that allows aluminum ions to conduct through it between the anode 11 and the air electrode 12.

The aluminum-containing material used to form the anode 11 is preferably, for example, a material including aluminum as a main component, such as elemental aluminum or any of various aluminum alloys. The anode 11 may be in any shape such as a foil, a sheet, or a plate, and may also be in any form such as a bulk, mesh, or porous form.

The cathode 12 is capable of reducing oxygen under neutral or near-neutral conditions, for example, at a pH of 3 to 10, preferably at a pH of 3 to 9, more preferably at a pH of 3 to 8. Specifically, for example, the cathode 12 may be an immobilized enzyme electrode having an immobilized oxygen-reducing enzyme. Examples of the oxygen-reducing enzyme include, but are not limited to, bilirubin oxidase, laccase, and ascorbate oxidase. In addition to the oxygen-reducing enzyme, an electron mediator capable of transferring electrons between the oxygen-reducing enzyme and the cathode 12 is preferably immobilized on the cathode 12. Examples of the electron mediator include, but are not limited to, potassium hexacyanoferrate and potassium octacyanotungstate.

At the cathode 12, oxygen in the air is reduced in the presence of the oxygen-reducing enzyme by electrons from the anode 11 and protons (H⁺) from the separator 13 filled with the electrolytic solution to produce water. The separator 13 may be, for example, made of a porous membrane or a nonwoven fabric of polyethylene, polypropylene, or other materials. Examples of materials for the nonwoven fabric include, but are not limited to, various types of organic polymer compounds such as polyolefin, polyester, cellulose, and polyacrylamide.

The collector 14 typically includes a metal mesh. The metal mesh may be made of any material capable of withstanding the environment in which the direct aluminum fuel cell is used. Examples of such a material generally include titanium (Ti), nickel (Ni), and stainless steel (e.g., SUS 304). The pore size and other features of the metal mesh are not restricted and may be selected as needed. The collector 15 is designed to be permeable to the electrolytic solution. The collector 15 typically includes a metal mesh like the collector 14.

The electrolytic solution used preferably has a pH of 3 to 10. The electrolytic solution contains a buffer substance. In this example, the buffer substance has a pKₐ of 4 to 10. Examples of the buffer substance include citric acid, ammonium chloride, phosphoric acid, trishydroxymethylaminomethane, imidazole ring-containing compounds, dihydrogen phosphate ion (H₂PO₄⁻), 2-amino-2-hydroxymethyl-1,3-propanediol (abbreviated as Tris), 2-(N-morpholino)ethanesulfonic acid (MES), cacodylic acid, carbonic acid (H₂CO₃), hydrogen citrate ion, N-(2-acetoamido)iminodiacetic acid (ADA), piperazine-N,N′-bis(2-ethanesulfonic acid) (PIPES), N-(2-acetoamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviated as Tricine), glycylglycine, and N,N-bis(2-hydroxyethyl)glycine (abbreviated as Bicine). Examples of substances capable of producing dihydrogen phosphate ions (H₂PO₄) include sodium dihydrogen phosphate (NaH₂PO₄) and potassium dihydrogen phosphate (KH₂PO₄). Examples of imidazole ring-containing compounds include imidazole, triazole, pyridine derivatives, bipyridine derivatives, and imidazole derivatives (histidine, 1-methylimidazole, 2-methylimidazole, 4-methylimidazole, 2-ethylimidazole, ethyl imidazole-2-carboxylate, imidazole-2-carboxaldehyde, imidazole-4-carboxylic acid, imidazole-4,5-dicarboxylic acid, imidazol-1-yl-acetic acid, 2-acetylbenzimidazole, 1-acetylimidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, and 1-butylimidazole). If necessary, the electrolytic solution may contain, as a neutralizer, at least one acid, for example, selected from the group consisting of hydrochloric acid (HCl), acetic acid (CH₃COOH), phosphoric acid (H₃PO₄), and sulfuric acid (H₂SO₄) in addition to the buffer substance.

The buffer substance-containing electrolytic solution may also contain, for example, a substance containing a halide ion (such as a chloride ion, a bromide ion, an iodide ion, or a fluoride ion). For example, when a chloride ion-containing substance is added to the buffer substance-containing electrolytic solution, the chloride ion-containing substance may be NaCl, KCl, or the like. The electrolytic solution to be used may also contain an ionic liquid. Any conventionally known ionic liquid may be used, which may be selected as needed.

A gas-liquid separation membrane may be used to form a vessel for containing the electrolytic solution. As a non-limiting example, a polytetrafluoroethylene (PTFE) membrane is preferably used to form the vessel.

The shape of the vessel is selected as needed. The cathode, the anode, the separator, the electrolytic solution, and other components may be housed in a battery case (vessel), which may be in the form of a coin, a flat plate, a cylinder, a laminate, or other forms. The battery case may be of an open-to-atmosphere type having a structure that allows at least the cathode to sufficiently contact with the atmosphere. Alternatively, the battery case may be of a closed type having a gas (air)-introducing duct and an exhaust duct.

The anode 11 is formed by a conventionally known method depending on the material used. Subsequently, the collector 14 is electrically connected to the upper surface of the anode 11. On the other hand, the cathode 12 with an immobilized oxygen-reducing enzyme is formed by dipping the cathode 12 into an enzyme solution containing a dissolved oxygen-reducing enzyme or applying the enzyme solution to the cathode 12. Subsequently, the collector 15 is electrically connected to the upper surface of the cathode 12. The separator 13 is then sandwiched between the anode 11 and the cathode 12, and the anode 11, the cathode 12, and the separator 13 are immersed in the electrolytic solution 17. Thus, the direct aluminum fuel cell shown in FIG. 1A is obtained.

FIG. 1B is a schematic cross-sectional view showing a modified example of the direct aluminum fuel cell. In this example, the whole of the anode 11, the whole of the cathode 12, and at least part of the separator 13 between the anode 11 and the cathode 12 are immersed in the electrolytic solution 17, which is contained in a vessel 16 including a gas-liquid separation membrane. This direct aluminum fuel cell can be obtained by a process that includes placing, in the vessel 16, the whole of the anode 11, the whole of the cathode 12, and part of the separator 13 between the anode 11 and the cathode 12, adding the electrolytic solution 17 to the vessel 16, and sealing the vessel 16. End parts of the separator 13 may protrude from the vessel 16. Such a structure makes it possible to completely separate the spaces for the cathode 12 and the anode 11 and to prevent the reaction product (aluminum hydroxide) at the anode 11 from moving to the cathode side. The cell life can be extended by preventing the reaction product from moving.

At least one of the anode 11 and the cathode 12 may be integrally formed with the separator 13 so that the manufacturing process can be simplified, the anode 11 or the cathode 12 can have higher mechanical strength, or the movement of protons between the anode 11 and the cathode 12 can be facilitated. The anode 11 and the cathode 12 may be integrally formed with the separator 13. In this case, one of the anode 11 and the cathode 12 may be formed on one surface of the separator 13, and the other of the anode 11 and the cathode 12 may be formed on the other surface of the separator 13.

In this direct aluminum fuel cell, the reactions represented by formulae (1) to (3) below occur at the anode 11 during power generation. Formula (4) is obtained from formulae (2) and (3).

Al→Al³⁺+3e⁻ (1)

Al³⁺+6H₂O→[Al (H₂O)₆]³⁺ (2)

[Al(H₂O)₆]³⁺→[Al(OH)₆]³⁻+6H⁺ (3)

Al³⁺+6H₂O→[Al(OH)₆]³⁻+6H⁺ (4)

In this process, Al³⁺ moves from the anode 11 to the cathode 12 through the separator 13 so that electrical energy is generated. At the cathode 12, oxygen in the air is reduced in the presence of an oxygen-decomposing enzyme by electrons from the anode 11 and H⁺ from the separator 13 filled with the electrolytic solution 17 to produce water.

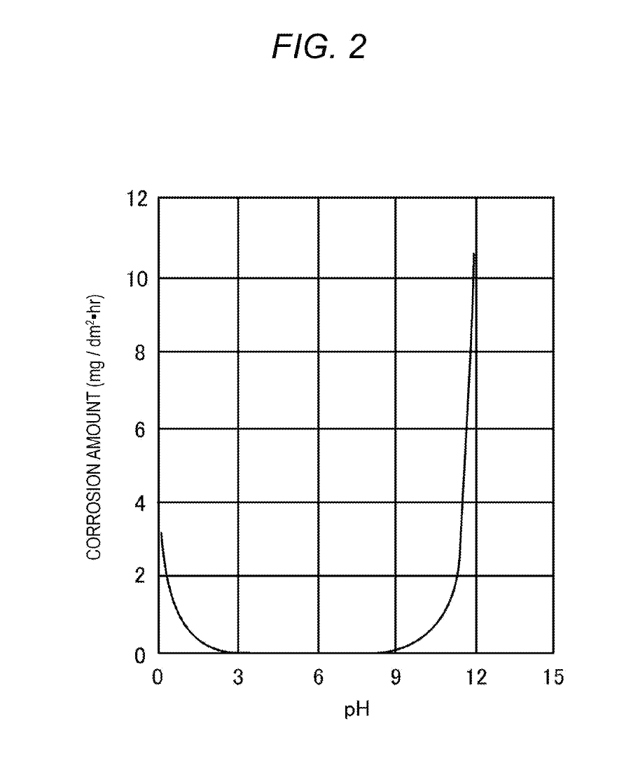

As is apparent from formula (4), protons are accumulated on the surface of the anode 11, and therefore, unless any measures are taken, the pH at the surface of the anode 11 will decrease so that the aluminum can undergo self corrosion to promote the production of hydrogen gas. In Example 1, however, the electrolytic solution 17 contains a buffer substance with a pKₐ of 4 to 10, which acts to keep the pH at the surface of the anode 11 neutral or near-neutral (for example, to keep the pH at 3 to 10), so that the aluminum is prevented from undergoing self corrosion and from promoting the production of hydrogen gas. Specifically, FIG. 2 shows the relationship between pH and the amount of corrosion of aluminum, which indicates that when the pH falls within the range of 3 to 10, almost no corrosion occurs, or the amount of corrosion is very small, so that the production of hydrogen gas can be suppressed.

The direct aluminum fuel cell was prepared as described below. Specifically, a square aluminum foil with a dimension of 10 mm×10 mm×12 μm was used as the anode 11. A titanium mesh was electrically connected as the collector 14 to the aluminum foil. An immobilized enzyme electrode including a porous carbon electrode with a dimension of 10 mm×10 mm×2 mm and bilirubin oxidase (BOD) immobilized as an oxygen-reducing enzyme on the carbon electrode was used as the cathode 12. A titanium mesh was electrically connected as the collector 15 to the immobilized enzyme electrode. The separator 13 made of a nonwoven fabric was then sandwiched between the anode 11 and the cathode 12. The resulting laminate of the anode 11/separator 13/cathode 12 was placed in the vessel 16 made of a PTFE membrane, and the vessel 16 was charged with the electrolytic solution 17 and then sealed. The electrolytic solution 17 was a 3 mol/liter NaCl solution containing imidazole as a buffer substance and HCl as a neutralizer and having a pH of 7. The content of the buffer substance was 2 mol per liter of the electrolytic solution.

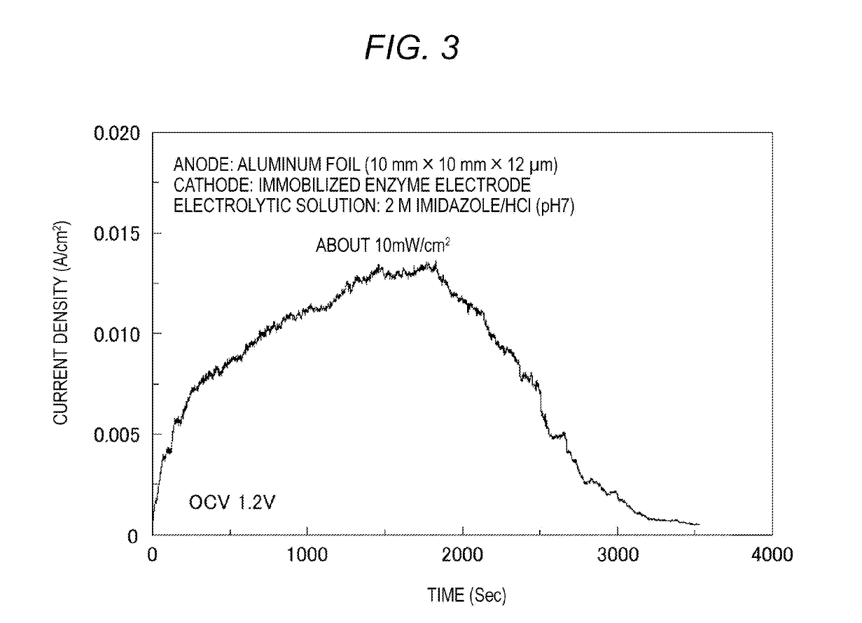

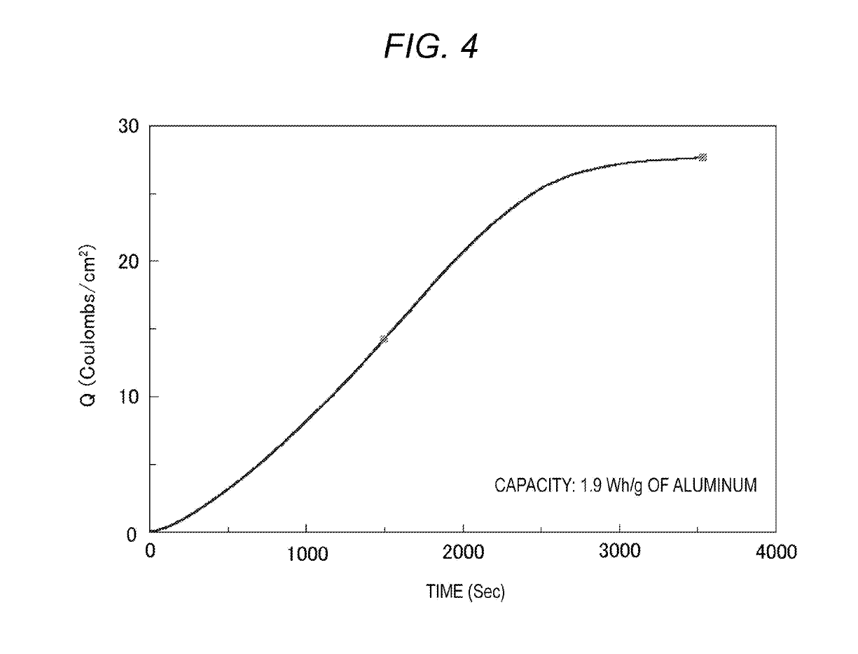

The output characteristics of the prepared direct aluminum fuel cell were measured at a cell voltage of 0.7 V. FIG. 3 shows the results of the measurement. About 3,500 seconds after the power generation (discharge) was started, the aluminum foil was entirely leached out, and the power generation was ended. The maximum current density was 0.013 A/cm², and the power was about 10 mW/cm². FIG. 4 shows the amount of electric charges output during the period from the start to the end of the power generation. It shows that the cell has a capacity of 1.9 Wh per g of aluminum. After the power generation was ended, a by-product aluminum hydroxide (Al(OH)₃) remained as an insoluble residue in the electrolytic solution 17.

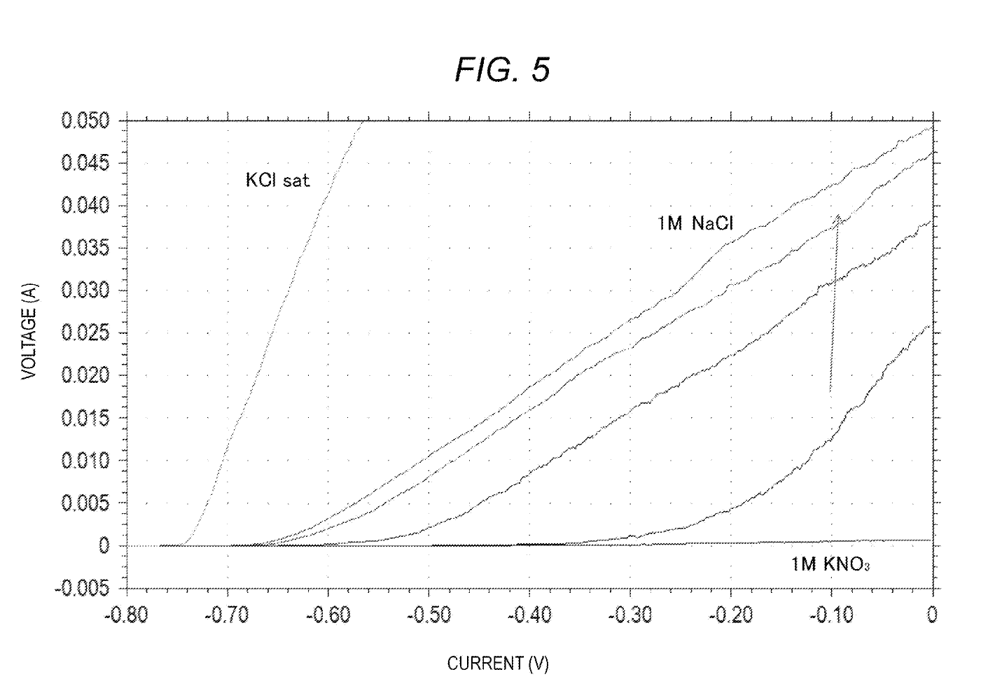

Hereinafter, the advantageous effect of the electrolytic solution 17 including NaCl will be described. FIG. 5 shows the results of the oxidation reaction of a 1 cm²-area aluminum foil with different electrolytic solutions. The electrolytic solutions were prepared using a 1 mol/liter NaCl aqueous solution, a saturated KCl aqueous solution, and a 1 mol/liter KNO₃ aqueous solution, respectively. FIG. 5 shows that the oxidation reaction hardly proceeds when the KNO₃-containing electrolytic solution is used. However, it is apparent that the oxidation reaction proceeds when the NaCl- or KCl-containing electrolytic solution is used. This means that chloride ions, more generally, halide ions, contained in the electrolytic solution play an important role for the occurrence of the oxidation reaction.

As described above, the direct aluminum fuel cell of Example 1 uses an aluminum-containing material as the anode 11 serving as a fuel and also uses, as the cathode 12, an immobilized enzyme electrode capable of decomposing oxygen under neutral or near-neutral conditions, which makes it possible to prevent the corrosion of the aluminum of the anode 11 used as a fuel and to prevent the degradation of the cathode 12. This direct aluminum fuel cell is also advantageous in that it is safe because the electrolytic solution 17 is neutral or near-neutral.

### Example 2

Example 2 is a modification of Example 1. In Example 2, citric acid was used as the buffer substance in the electrolytic solution 17 instead of imidazole. The content of the buffer substance was 1 mol per liter of the electrolytic solution. The direct aluminum fuel cell was prepared as in Example 1, except for these features. The output characteristics of the direct aluminum fuel cell of Example 2 were measured. The results of the measurement were similar to those of Example 1, but after the power generation was ended, an insoluble by-product aluminum hydroxide did not remain in the electrolytic solution 17.

### Example 3

Example 3 is another modification of Example 1. A direct aluminum fuel cell of Example 3 has a cathode 12 different from that of Example 1. Specifically, for example, the cathode 12 includes an electrode material capable of reducing oxygen, or the cathode 12 includes an electrode including an electrode material and a catalyst capable of reducing oxygen, which is supported on the electrode material. The electrode material may be, for example, a carbon material or a metal material.

In this example, when the cathode 12 includes a carbon material, the carbon material may be in the form of at least one selected from the group consisting of carbon particles, a carbon sheet, and carbon fibers. For example, carbon particles include at least one selected from the group consisting of activated carbon, carbon black, and biocarbon. Alternatively, carbon particles may be other than these. Examples of activated carbon include wood charcoal such as oak charcoal, sawtooth oak charcoal, cedar charcoal, Japanese oak charcoal, or cypress charcoal, rubber charcoal, bamboo charcoal, charcoal from wood briquettes, and coconut shell charcoal.

Examples of carbon black include furnace black, acetylene black, channel black, thermal black, and Ketjen black. In particular, Ketjen black is preferred. Biocarbon is a porous carbon material that is made from a plant-derived raw material with a silicon content of 5% by weight or more, has a specific surface area of 10 m²/g or more as measured by nitrogen BET method, has a silicon content of 1% by weight or less, and has a pore volume of 0.1 cm³/g or more as measured by BJH method and MP method (see Patent Document 4). Specifically, for example, biocarbon is produced as follows. First, ground rice hulls

(Isehikari rice hulls produced in Kagoshima prefecture, Japan) were turned into charcoal by heating at 500° C. for 5 hours in a nitrogen stream, so that a charcoal material was obtained. Subsequently, 10 g of the charcoal material was added to an alumina crucible and then heated to 1,000 at a rate of temperature rise of 5° C./minute in a nitrogen stream (10 liter/minute). Subsequently, the material was turned into a carbonaceous material (porous carbon material precursor) by carbonization at 1,000° C. for 5 hours. The carbonaceous material was then cooled to room temperature. The nitrogen gas continued to flow during the carbonization and the cooling. The porous carbon material precursor was then subjected to an acid treatment by being immersed in a 46% by volume hydrofluoric acid aqueous solution overnight, so that SiO₂ was removed, or the porous carbon material precursor was then subjected to an alkali treatment by being immersed in an aqueous sodium hydroxide solution overnight, so that SiO₂ was removed. Subsequently, the product was washed with water and ethyl alcohol until a pH of 7 was reached. Finally, the product was dried to give a porous carbon material, namely, biocarbon.

Alternatively, the cathode 12 may include a metal material. In this case, the metal material may be, for example, at least one simple metal selected from the group consisting of cobalt (Co), iridium (Ir), platinum (Pt), silver (Ag), gold (Au), ruthenium (Ru), rhodium (Rh), osmium (Os), niobium (Nb), molybdenum (Mo), indium (In), zinc (Zn), manganese (Mn), iron (Fe), titanium (Ti), vanadium (V), chromium (Cr), palladium (Pd), rhenium (Re), tantalum (Ta), tungsten (W), zirconium (Zr), germanium (Ge), and hafnium (Hf), or an alloy thereof.

The catalyst may be made of, for example, any of a variety of inorganic ceramics such as manganese dioxide (MnO₂) (such as electrolytic manganese dioxide (EMD)), tricobalt tetraoxide (Co₃O₄), nickel oxide (NiO), iron(III) oxide (Fe₂O₃), ruthenium(IV) oxide (RuO₂), copper(II) oxide (CuO), vanadium pentaoxide (V₂O₅), molybdenum(VI) oxide (MoO₃), yttrium(III) oxide (Y₂O₃), and iridium(IV) oxide (IrO₂). Alternatively, the catalyst may be made of, for example, at least one material selected from the group consisting of various precious metals such as gold (Au), platinum (Pt), and palladium (Pd), transition metal oxides, organometallic complexes and polymers thereof (specifically, for example, transition metal porphyrin, phthalocyanine, polymerized porphyrin obtained by polymerization of transition metal porphyrin, and polymerized phthalocyanine obtained by polymerization of phthalocyanine), perovskite, and a product of thermal decomposition of a cobalt salt and polyacrylonitrile. Alternatively, the catalyst may be made of any of other materials including LaBO₃ (B: Mn, Co) perovskite oxides, nitrides, or sulfides, and multicomponent perovskite oxides such as La₁₋ₓA′ₓCo_{1-y}Fe_{y}O₃, wherein A′ is Sr or Ca, and x and y are each from 0.2 to 0.5.

The direct aluminum fuel cell of Example 3 may be the same as the direct aluminum fuel cell of Example 1, except that the cathode 12 has the different features.

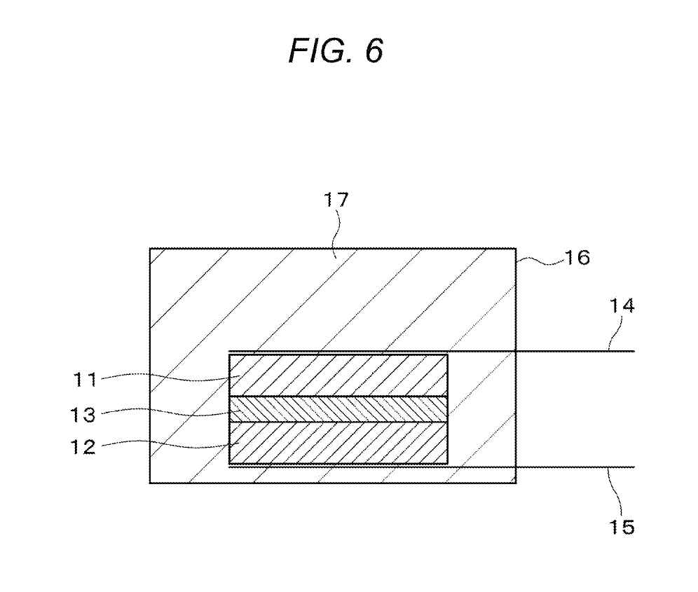

FIG. 6 is a schematic cross-sectional view showing the direct aluminum fuel cell. In this example, the anode 11, the cathode 12, and the separator 13 are entirely immersed in the electrolytic solution 17 contained in the vessel 16 including the gas-liquid separation membrane. The direct aluminum fuel cell of Example 3 can be produced in the same way as the direct aluminum fuel cell of Example 1, except that the cathode 12 is formed of the electrode material capable of reducing oxygen or formed by depositing, on the electrode material, the catalyst capable of reducing oxygen. The direct aluminum fuel cell of Example 3 is also operated in the same way as the direct aluminum fuel cell of Example 1.

The direct aluminum fuel cell of Example 3 was prepared as described below. Specifically, a square aluminum mesh with a dimension of 10 mm×10 mm×170 μm was used as the anode 11. A titanium mesh was electrically connected as the collector 14 to the aluminum mesh. The cathode 12 was prepared by applying biocarbon to the separator 13 made of a nonwoven fabric with a dimension of 10 mm×10 mm×200 μm. A titanium mesh was electrically connected as the collector 15 to the cathode 12. The aluminum mesh anode 11 and the biocarbon cathode 12 were bonded together with the nonwoven fabric separator 13 placed therebetween. The resulting laminate of the anode/separator/cathode was placed in the vessel 16 made of a PTFE membrane, and the vessel 16 was charged with the electrolytic solution 17 and then sealed. The electrolytic solution 17 used was a 4 mol/liter NaCl aqueous solution with a pH of 7. Phosphoric acid was also added at a final concentration of 1.0 mol to the solution, and the pH of the solution was adjusted to 7 with potassium hydroxide.

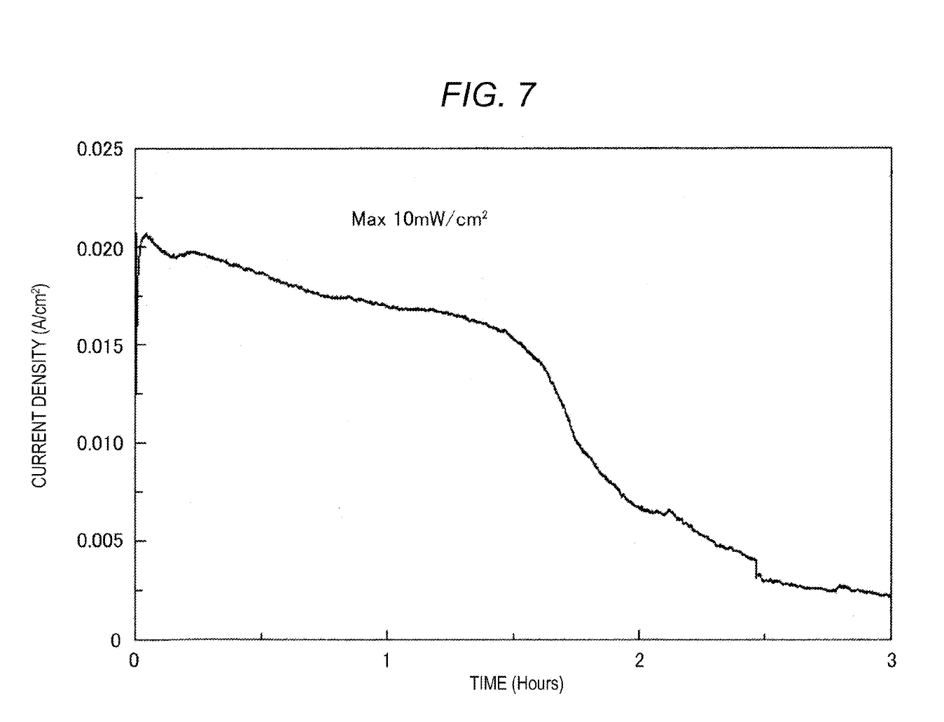

The output characteristics of the prepared direct aluminum fuel cell of Example 3 were measured at a cell voltage of 0.7 V. FIG. 7 shows the results of the measurement. The fuel cell continuously generated electricity for at least 3 hours after the start of power generation (the start of discharge). The maximum current density was 0.020 A/cm², and the power was about 10 mW/cm². The direct aluminum fuel cell of Example 3 has the same advantages as the direct aluminum fuel cell of Example 1.

### Example 4

Example 4 is a modification of Examples 1 to 3. The direct aluminum fuel cell of Example 4 differs from the direct aluminum fuel cells of Examples 1 to 3 in that the anode 11 as a fuel is exchangeably provided.

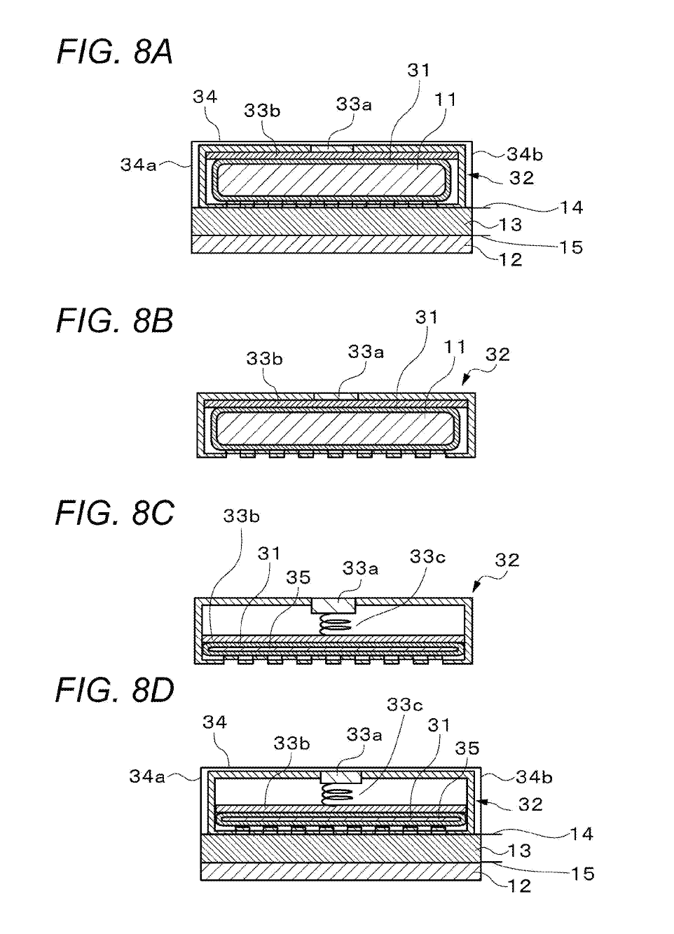

FIG. 8A is a schematic cross-sectional view showing Example 4 in which the anode 11 as a fuel is covered with a bag-shaped membrane 31 permeable to the electrolytic solution 17. The anode 11 covered with the bag-shaped membrane 31 is housed in a fuel cartridge 32. The fuel cartridge 32 is housed in a fuel cartridge housing 34. The fuel cartridge housing 34 is mounted on the separator 13. Reference numerals 33a and 33b represent fuel pushing members. The fuel cartridge housing 34 has a cartridge insertion port 34a through which the fuel cartridge 32 is to be inserted from the outside to the inside. The fuel cartridge housing 34 also has a cartridge discharge port 34b through which the fuel cartridge 32 is to be taken out to the outside.

FIG. 8B is a schematic cross-sectional view showing the fuel cartridge 32 not in use. FIG. 8C is a schematic cross-sectional view showing the state after the anode 11 as a fuel in the fuel cartridge 32 is completely consumed. FIG. 8D is also a schematic cross-sectional view showing the direct aluminum fuel cell in which the anode 11 is completely consumed. After use, aluminum hydroxide 35 as a by-product is trapped in the bag-shaped membrane 31. In FIGS. 8B and 8C, reference numeral 33c represents a pushing spring with its both ends fixed to the fuel pushing members 33a and 33b, respectively. The fuel pushing member 33a is fixed to the fuel cartridge 32, and the fuel pushing member 33b presses the anode 11 against the separator 13 by means of the spring 33c.

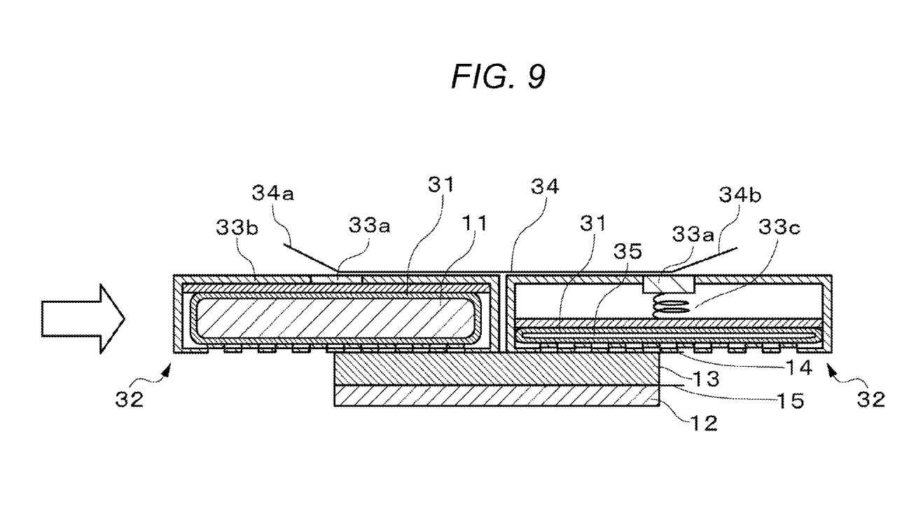

The used fuel cartridge 32 can be replaced with an unused fuel cartridge 32 by the following operation. Specifically, as shown in the schematic cross-sectional view of FIG. 9, the cartridge insertion port 34a is opened, and the unused fuel cartridge 32 is inserted into the fuel cartridge housing 34, so that the used fuel cartridge 32 is pushed to the outside through the cartridge discharge port 34b. When the used fuel cartridge 32 is completely pushed to the outside through the cartridge discharge port 34b, the unused fuel cartridge 32 is set in place, so that the state shown in FIG. 8A is obtained. In this state, the anode 11 in the fuel cartridge 32 is pressed against the separator 13 by means of the fuel pushing member 33b.

The direct aluminum fuel cell of Example 4 has the same features as those of the direct aluminum fuel cells of Examples 1 to 3, except for the features described above.

While the present disclosure has been described based on preferred examples, it will be understood that these examples are not intended to limit the present disclosure and that various modifications of these examples are possible. The values, structures, configurations, shapes, materials, and other features shown in the examples are only by way of example, and if necessary, values, structures, configurations, shapes, materials, and other features different from the above may also be used. It will also be understood that any two or more of Examples 1 to 4 may be combined.

The present disclosure may have the following features.
[1] <<First mode of direct aluminum fuel cell>>A direct aluminum fuel cell including: an anode including an aluminum-containing material; a cathode capable of reducing oxygen under neutral or near-neutral conditions; and an electrolytic solution with a pH of 3 to 10, wherein the electrolytic solution contains a buffer substance.

[2] The direct aluminum fuel cell according to [1], wherein the buffer substance has a pKₐ of 4 to 10.

[3] The direct aluminum fuel cell according to [1] or [2], wherein the cathode is capable of reducing oxygen under conditions with a pH of 3 to 10.

[4] The direct aluminum fuel cell according to any one of [1] to [3], wherein the electrolytic solution contains halide ions.

[5] The direct aluminum fuel cell according to [4], wherein the halide ions are chloride ions.

[6] The direct aluminum fuel cell according to any one of [1] to [5], further including an oxygen-reducing enzyme immobilized on the cathode.

[7] The direct aluminum fuel cell according to any one of [1] to [6], wherein the cathode includes carbon or metal or contains a catalyst.

[8] The direct aluminum fuel cell according to any one of [1] to [6], wherein the cathode contains a catalyst capable of allowing oxygen to undergo four-electron reduction under neutral or near-neutral conditions.

[9] The direct aluminum fuel cell according to [8], wherein the catalyst is an enzyme.

[10] The direct aluminum fuel cell according to any one of [1] to [9], further including a separator between the cathode and the anode.

[11] The direct aluminum fuel cell according to any one of [1] to [10], which has a foil shape, a sheet shape, or a plate shape.

[12] The direct aluminum fuel cell according to any one of [1] to [11], wherein at least part of the anode is mesh-shaped or includes a porous material.

[13] The direct aluminum fuel cell according to any one of [1] to [12], wherein the anode includes an aluminum foil.

[14] The direct aluminum fuel cell according to any one of [1] to [13], wherein the anode is exchangeably provided.

[15] The direct aluminum fuel cell according to [14], which is so configured that an insoluble material as a by-product can be removed simultaneously with exchange of the anode.

[16] <<Second mode of direct aluminum fuel cell>>A direct aluminum fuel cell including: an anode including an aluminum-containing material; and a cathode capable of reducing oxygen under neutral or near-neutral conditions.

[17] The direct aluminum fuel cell according to [16], wherein the cathode is capable of reducing oxygen under conditions with a pH of 3 to 10.

[18] <<Electronic device>>An electronic device including at least one piece of the direct aluminum fuel cell according to any one of [1] to [17].

### REFERENCE SIGNS LIST

11 Anode
12 Cathode
13 Separator
14,15 Collector
16 Vessel
17 Electrolytic solution
31 Bag-shaped membrane
32 Fuel cartridge
34 Fuel cartridge housing
33a, 33b Fuel pushing member
33c Pushing spring
34a Cartridge insertion port
34b Cartridge discharge port
35 By-product (aluminum hydroxide)

1. A direct aluminum fuel cell comprising: an anode having an aluminum-containing material; a cathode capable of reducing oxygen under neutral or near-neutral conditions; and an electrolytic solution with a pH of 3 to 10, wherein the electrolytic solution contains a buffer substance.

2. The direct aluminum fuel cell according to claim 1, wherein the buffer substance has a pKₐ of 4 to 10.

3. The direct aluminum fuel cell according to claim 1, wherein the cathode is capable of reducing oxygen under conditions with a pH of 3 to 10.

4. The direct aluminum fuel cell according to claim 1, wherein the electrolytic solution contains halide ions.

5. The direct aluminum fuel cell according to claim 4, wherein the halide ions are chloride ions.

6. The direct aluminum fuel cell according to claim 1, further comprising an oxygen-reducing enzyme immobilized on the cathode.

7. The direct aluminum fuel cell according to claim 1, wherein the cathode includes carbon or metal or contains a catalyst.

8. The direct aluminum fuel cell according to claim 1, wherein the cathode contains a catalyst capable of allowing oxygen to undergo four-electron reduction under neutral or near-neutral conditions.

9. The direct aluminum fuel cell according to claim 8, wherein the catalyst is an enzyme.

10. The direct aluminum fuel cell according to claim 1, further comprising a separator between the cathode and the anode.

11. The direct aluminum fuel cell according to claim 1, which has a foil shape, a sheet shape, or a plate shape.

12. The direct aluminum fuel cell according to claim 1, wherein at least part of the anode is mesh-shaped or includes a porous material.

13. The direct aluminum fuel cell according to claim 1, wherein the anode includes an aluminum foil.

14. The direct aluminum fuel cell according to claim 1, wherein the anode is exchangeably provided.

15. The direct aluminum fuel cell according to claim 14, which is so configured that an insoluble material as a by-product can be removed simultaneously with exchange of the anode.

16. A direct aluminum fuel cell comprising: an anode having an aluminum-containing material; and a cathode capable of reducing oxygen under neutral or near-neutral conditions.

17. The direct aluminum fuel cell according to claim 16, wherein the cathode is capable of reducing oxygen under conditions with a pH of 3 to 10.

18. An electronic device having at least one direct aluminum fuel cell comprising: an anode having an aluminum-containing material; a cathode capable of reducing oxygen under neutral or near-neutral conditions; and an electrolytic solution with a pH of 3 to 10, wherein the electrolytic solution contains a buffer substance.
